(19) United States
(12) Patent Application Publication
(10) Pub. No.: US 2006/0244211 A1
(43) Pub. Date: Nov. 2, 2006

(54) Gaming machine

(75) Inventor: Akira Osawa, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/412,089

(22) Filed: Apr. 27, 2006

(30) Foreign Application Priority Data
Apr. 28, 2005 (JP) 2005-130932

(51) Int. Cl. A63F 13/00; A63F 9/24; A63F 1/18; A63B 71/00

(52) U.S. Cl. 273/139; 273/143 R; 463/20; 463/25

(57) ABSTRACT

An object of the present invention is to provide a gaming machine such as a slot machine and the like capable of meeting expectation of a player for the free game and sustaining the interest of the player. The free game processing (S5) of the slot machine 1 according to the present invention adds 1 each to the numerical values of the win counter m for every occurrence of an winning combination (S47), and terminates the free game processing (S5) only when the numerical values of the win counter m become the same values as the free game terminal condition values s (S48: YES). On the other hand, when no winning combinations occur (S46: NO), the numerical values of the loss counter n is added by 1 each for every time (S49), and when the numerical values of the loss counter n become 20 (S50: YES), the numerical values of the free game termination condition values s which become the termination conditions of the free game are changed from “10” to “15”.

The present disclosure relates to subject matters contained in Japanese Patent Application No. 2005-130932 filed on Apr. 28, 2005, which are expressly incorporated herein by reference in its entireties.

### BACKGROUND OF THE INVENTION

1. Field of the Invention

The present invention relates to a gaming machine such as a slot machine and the like capable of executing a so-called free game providing a payout according to each of winning combinations in the case where a combination of symbols determined by the lottery means corresponds to the winning combination without using a gaming medium by satisfying predetermined conditions, and in particular, it relates to a gaming machine enhancing absorbing interest in the free game.

2. Description of the Prior Art

Heretofore, in general, a slot machine is configured such that a plurality of reels formed with various types of symbols on the peripheral surface are rotatably provided, and when the symbol in each reel is stopped and displayed on an active payline with a predetermined combination, a gamely medium such as a medal and the like is paid out.

In the case of the slot machine widely diffused abroad, after performing an operation relating to rotational start of the reel, an winning combination and a stop symbol in each reel are determined, and then, the rotation of each reel is started. When a predetermined period of time elapses from the rotational start of each reel, the symbols configuring a winning combination automatically determined are automatically stopped on the active payline, and based on the winning combination, gaming medium such as a medal and the like is paid out.

Here, in the slot machine for use abroad, as a result of performing the game as described above, a feature game capable of playing a game in an advantageous game state than usual can be played by satisfying the predetermined conditions. At present, while these feature games include various kinds of games, as one kind of the feature games, a free game is known.

The free game is a feature game capable of executing a free spin for a predetermined number of times in which the reels automatically start rotating without newly inserting a medal, and when a predetermined time elapses, the rotation stops by a combination of symbols based on a lottery result, and the medal and the like are paid out according to the winning combination.

As a technique relating to the slot machine adopting such free game as the feature game, a slot machine is disclosed in Japanese Patent Laid-Open No. 2005-034301 and Japanese Patent Laid-Open No. 2005-034302.

Here, in the slot machine adopting the free game as the feature game, when it proceeds to the free game, the operation relating to the rotational start of the reel is also automatically performed, and hence, a player is unable to participate in the free game, and the more increased the number of rotations of the free spin is, the longer the player is left in a state just looking at the rotation and stop of the reel. Consequently, in this free game, an attempt to allow the interest of the player in the game to sustain is required.

The slot machine disclosed in Japanese Patent Laid-Open No. 2005-034301 and Japanese Patent Laid-Open No. 2005-034302 makes an attempt to sustain the interest of the player in this free game.

These free games are one kind of the feature games as described above, and can realize a game in an advantageous state than usual, and thus, when proceeding to the free game, the player expects many profits (for example, acquisition of a large number of medals and credits).

Here, in the general free game, the termination of the free game is regulated by the number of processing times relating to a series of free spins from the rotation of the reels to the stop of the reels up to the paying out of the medals and the like. That is, it is common that the free game is terminated when the number of spin times reaches a predetermined number of times.

The lottery of the winning combination for each free spin is independently performed, and even when the free spin proceeds to the free game, a profit cannot be always obtained as expected by the player.

For example, even when the free spin proceeds to the free game executing free spins 10 times, there are often the cases where the free spin secures a winning combination only one time, and the remaining free spins are all “loss” or all the spins executed ten times are the “loss”.

Consequently, in such conventional free game, there are many cases where the betrayal of the expectation of the player to get many profits is resulted, and it is feared that the effect of the feature game is diminished.

Further, when the betrayal of the expectation of the player who acquires the free game is resulted frequently, it is assumed that the player does not expect much even if he acquires the free game as the feature game and ends up feeling no joy of acquiring the free game. Moreover, there is a possibility that this may develop into deterioration of the popularity of the gaming machine where the free game is adopted as the feature game.

On this point, in the slot machine disclosed in Japanese Patent Laid-Open No. 2005-034301 and Japanese Patent Laid-Open No. 2005-034302, even though an attempt is made to allow the interest of the player in the midst of executing the free game to sustain, with respect to the diminishing of the effect as the feature game of the free game, no attempt is made to deal with it, and there exists the same problem as that of the conventional slot machine as described above.

In view of the above-described problems, the present invention relates to a gaming machine such as a slot machine and the like capable of executing the free game, and in particular, it aims at providing a gaming machine such as a slot machine living up to the expectation of the player for the free game and capable of sustaining the interest of the player.

### SUMMARY OF THE INVENTION

The gaming machine (for example, slot machine 1) according to the present invention includes: a display for variably displaying a plurality of symbols (for example see FIG. 2), and displaying a combination of symbols by stopping to variably displaying the symbols (for example variable display portions 6 to 8); a lottery unit (for example, CPU61) for determining a combination of symbols displayed in the display; a first game control unit (for example, CPU61) for executing a first game (for example, S3) for providing a payout according to each winning combination in case the combination of symbols determined by the lottery unit corresponds to winning combinations; a second game control unit (for example, CPU61) for shifting from the first game to a second game (for example, S5) based on a predetermined condition and executing the second game for providing a payout according to each winning combination in the case that the combination of symbols determined by the lottery unit corresponds to winning combinations; and a win counter (for example, CPU61 and an win counter m) for counting the number of winning times during the second game, wherein the second game is terminated when the counting result of the win counter satisfies a second game termination condition based on the number of winning time during the second game.win counter Further, the gaming machine may further comprises a loss counter (for example, CPU 61 and a non-win counter n) for counting the number of loss times during the second game; and a termination condition changing unit (for example, CPU 61) for changing the termination condition of the second game whereby the counting result of the loss counter satisfies the termination condition changing condition based on the number of loss times during the second game.

### BRIEF DESCRIPTION OF THE DRAWINGS

FIG. 1 is a perspective view of a slot machine according to the present embodiment;

FIG. 2 is an explanatory drawing schematically showing a string of symbols displayed on the peripheral surfaces of reels used for the slot machine according to the present embodiment;

FIG. 3 is an explanatory drawing showing a drawing table for the winning combination in the slot machine according to the present embodiment;

FIG. 4 is an explanatory drawing showing a payout table for the winning combination in the slot machine according to the present embodiment;

FIG. 5 is a block diagram showing a control system of the slot machine according to the present embodiment;

FIG. 6 is a block diagram schematically showing a liquid crystal driving circuit of the slot machine according to the present embodiment;

FIG. 7 is a flowchart of a main processing program of the slot machine according to the present invention;

FIG. 8 is a flowchart of a start acceptance processing program of the slot machine according to the present embodiment;

FIG. 9 is a flowchart of the drawing processing program of the slot machine according to the present embodiment;

FIG. 10 is a flowchart of the base game processing program of the slot machine according to the present embodiment and;

FIG. 11 is a flowchart of a free game processing program of the slot machine according to the present embodiment.

The accompanying drawings, which are incorporated in and constitute a part of the specification, illustrate embodiments of the invention, and together with the general description given above and the detailed description of the embodiments given below, serve to explain the principles of the invention.

### DESCRIPTION OF THE PREFERRED EMBODIMENTS

Embodiments according to the present invention will be described below in detail with reference to the drawings.

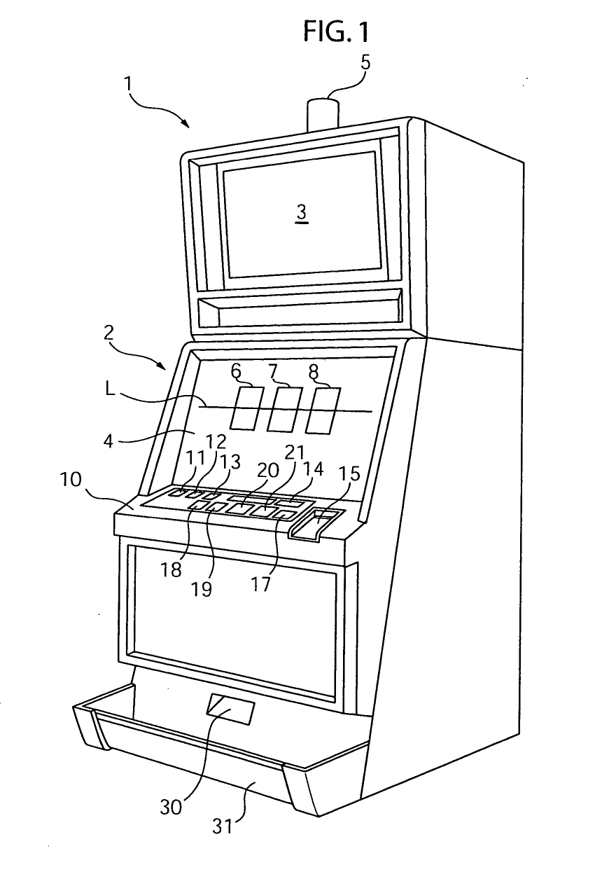

A gaming machine according to the present embodiment will be described below in detail based on the embodiment materializing a gaming machine according to the present invention in a slot machine with reference to the drawings. First, a schematic configuration of the slot machine according to the present embodiment will be described based on FIG. 1. FIG. 1 is a perspective view of the slot machine according to the present embodiment.

In FIG. 1, a slot machine 1 has a cabinet 2 forming its whole body, and in the front surface upper portion of the cabinet 2, there is provided an upper liquid crystal display 3. Further, in the front surface center portion of the cabinet 2, there is provided a lower liquid crystal display 4.

The upper liquid crystal display 3 is configured by a generally available liquid crystal display, and the lower liquid crystal display 4 is configured by a so-called transparent liquid crystal display. The upper liquid crystal display 3 is displayed with a game method, help information for assisting game operations such as types of winning combinations and payout and the like or information such as various representations and the like regarding the game. Further, above the upper liquid crystal display 3, there is provided a lamp 5, which is turned on when an error occurs or an attendant is called out.

On the other hand, the lower liquid crystal display 4, as shown in FIG. 1, is formed with variable display portions 6, 7 and 8 which are transmittance areas capable of seeing reels 25 to 27 provided at the backside of the lower liquid crystal display 4, where variable display portions 6, 7 and 8 are formed. In each of variable display portions 6 to 8, various types of symbols formed on the lateral surfaces of the reels 25 to 27 are variably displayed while being scrolled upward to downward.

Since the configuration of the transparent liquid crystal display is publicly known, the description thereof will be omitted.

At the bottom of the lower liquid crystal display 4, there is provided an operation table 10 protruded to the near side, and the operation table 10 is disposed with a currency exchange button 11, a collect button 12, a help button 13 from the left side seen from a position opposing to the gaming machine front face. Further, at the right side of the help button 13, there are provided a coin inserting slot 14, and a bill inserting slot 15.

Further, at the near side on the operation table 10, there are installed a 1-BET button 18, a repeat BET button 19, a 10-BET button 20, and a MAXBET button 21, and a start button 17 from the left side.

The currency exchange button 11 is a button pressed when exchanging a bill inserted to a bill inserting slot 15. The coin exchanged by a money exchanger (not shown) provided inside the slot machine is paid out into a coin tray 31 from a coin payout port 30 provided at the bottom of the cabinet 2. The currency exchange button 11 is attached with a currency exchange switch 65 to be described later, and based on the pressing of the currency exchange button 11, a switch signal from the currency exchange switch 65 is outputted to the CPU 61.

The collect button 12 is usually a button to be pressed at the game terminating time, and when the collect button 12 is pressed, the coins corresponding to the number of credits owned by the present player including the credit acquired in the game are discharged from the coin payout port 30 by a hopper 35, and paid out to the coin tray 31.

The help button 13 is a button to be pressed in the case where the operation method of the game and the like are unclear, and when the help button 13 is pressed, immediately after that, the upper liquid crystal display 3 is displayed with a help screen comprising various pieces of help information. The help button 13 is attached with a help switch 67 to be described later, and based on the pressing of the held button 13, a switch signal from the help switch 67 is outputted to the CPU 61.

The coin inserting slot 14 is installed with a coin sensor 74 to be described later, and when a coin is inserted to the coin inserting slot 14, a coin detecting signal is outputted to the CPU 61 through the coin sensor 47. Further, the bill inserting slot 15 is installed with a bill sensor 75, and when a bill is inserted to the bill inserting slot 15, a bill detecting signal is outputted to the CPU 61 through the bill sensor 75.

The 1-BET button 18, the 10-BET button 20, and the MAXBET button 21 are buttons for spending the number of credits and deciding the number of bets in one game based on the pressing of the buttons. That is, when the 1-BET button is pressed once, the number of bets is increased by 1, and when the 10-BET button 20 is pressed once, the number of bets is increased by 10. The MAXBET button 21 starts a game with 30 bets which is the maximum possible number of bets in one game. The start button 17 is a button which starts the rotation of the reels based on the number of bets betted by each of the BET buttons 18 to 21 and starts a game.

Further, the repeat BET button 19 is a button which starts variable displays of each symbol by each of the variable display portions 6 to 8 of the lower liquid crystal display 4 in order to start a game with the present number of bets or the previous number of bets based on the pressing of the repeat BET button 19. As the number of bets bettable by the pressing of the repeat BET button 19, there may exist 1 to 30 (MAX) bets.

At the bottom of the cabinet 2, there is formed the coin payout port 30, and there is provided the coin tray 31 for receiving the coin paid out from the coin payout port 30 when the game is terminated or the money is exchanged. Inside the coin payout port 30, there is installed a coin detecting portion 76 configured by a sensor and the like, and the coin detecting portion 76 detects the number of coins paid out from the coin payout port 30.

In the slot machine 1 in the present embodiment, by operating the operation table 10, the number of bets for the active payline L is determined and the rotational start of the reels 25 to 27 is instructed. Accompanied with the rotational start of the reels, the symbols scroll-displayed in the variable display portions 6 to 8, after the elapse of a definite time (about three seconds after the rotational start of the reels in the present embodiment), are stopped in order from the variable display portion 6 of the front face left side. At this time, when the symbols stopped on the active payline L correspond to the winning combination which are a predetermined combination of the symbols, the credit is increased, and the cycle from the bets of the credit to the stop of the rotation of the reels or to the payout of the credit based on the winning is referred to as one game.

Subsequently, the reels rotatably provided inside the cabinet 2 at the back side of the lower liquid crystal display 4 will be described.

At the back side of the lower liquid crystal display 4, there are three reels 25 to 27 rotatably supported in a parallel state and independently, and by each of the reels 25 to 27, the base and free games to be described later are played. From among the three reels 25 to 27, the reel 25 at the left side seen from the front face of the slot machine 1 is opposed to the variable display portion 6 (see FIG. 1) formed in the lower liquid crystal display 4, and the medial reel 26 is opposed to the variable display portion 7 (see FIG. 1) formed similarly in the lower liquid crystal display 4, and further, the right side reel 27 is opposed to the variable display portion 8 (see FIG. 1) formed similarly in the lower liquid crystal display 4.

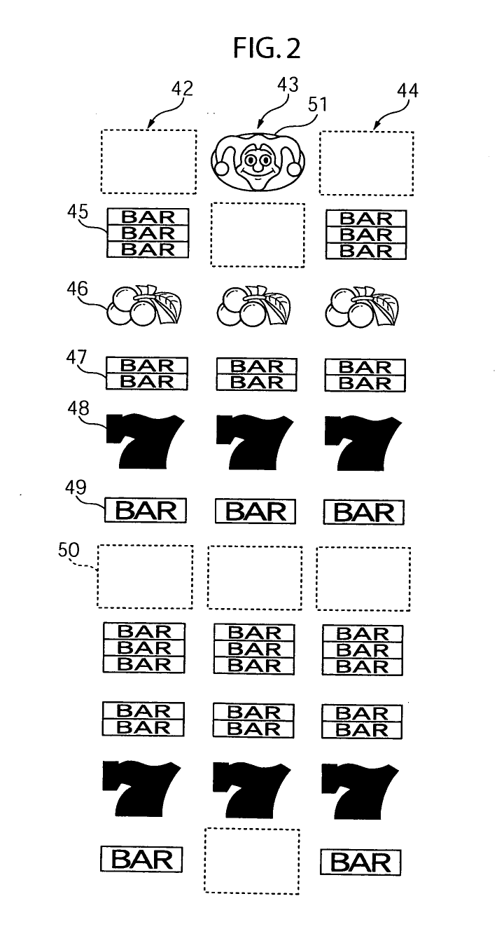

Then, as shown in FIG. 2, the lateral surface of each of the reels 25 to 27 is depicted with a string of symbols. Consequently, each symbol string is variably displayed while being scrolled at each of the variable display portions 6 to 8 based on the rotational start of each of the reels 25 to 27. Here, the string of symbols depicted in each of the reels 25 to 27 will be described. FIG. 2 is a schematic illustration showing each string of symbols depicted on the reels 25 to 27.

In FIG. 2, a string of symbols 42 is a string of symbols variably displayed in the variable display portion 6, a string of symbols 43 is a string of symbols variably displayed in the variable display portion 7, and a string of symbols 44 is a string of symbols variably displayed in the variable display portion 8.

Both the strings of symbols 42 and 44 have the same symbol configuration, and each of these stings of symbols is configured by an appropriate combination of each of a triple BARs 45, a cherry 46, a double BARs 47, a seven 48, and a single BARs 49 and a blank 50 which is a region in which there exists no symbol. That is, the strings of symbols 42 and 44 are configured by eleven symbols including the blank 50.

On the other hand, the string of symbols 43 is the same as each of the stings of symbols 42 and 44 in that a triple BARs 45, a cherry 46, a double BARs 47, a seven 48, a single BARs 49, and a blank 50 are combined, but it is further provided with one trigger symbol 51. The trigger symbol 51 is a symbol for triggering the free game, and when it is stop-displayed on the active payline L in the variable display portion 7, an base game can be shifted to the free game.

The free game is a game continuously played after the base game is played, and in general, it is often the game advantageous to the player.

When the base game is shifted to the free game, it is possible to play the game with the slot machine 1 without betting the credit. That is, the game by the slot machine can be enjoyed multiple times without spending the credit in the possession of the player. The number of bets in this free game uses the number of bets betted on the active payline L when the trigger symbol 51 occurs.

The free game in the present embodiment shall be terminated upon winning ten times for the winning combinations, and moreover, in the case where the predetermined conditions are satisfied, the game shall be played without spending the credit until winning five times for the winning combination.

When each type of the symbol is formed on the lateral surface of each of the reels 25 to 27, symbols are printed on a reel sheet of continuous length corresponding to the width and peripheral length of each of the reels 25 to 27, and the reel sheet is generally adhered on the lateral surface of each of the reel sheets 25 to 27, but it is naturally possible to form the symbols by methods other than this.

As described above, in the slot machine 1 of the present embodiment, when each of the string of symbols 42 to 44 scrolled in each of the variable display portions 6 to 8 is stop-displayed, three symbols are stop-displayed in each of the variable display portions. The symbols stop-displayed at that time are determined by the result of an internal lottery to be described later, and based on that result, the reels 25 to 27 are stop-controlled.

Further, the winning combination of each type is set in advance based on the multiple types of combinations of each symbol, and when the combination of the symbols corresponding to the winning combination is stopped on the active payline L (see FIG. 1), the credit is added according to the winning combination.

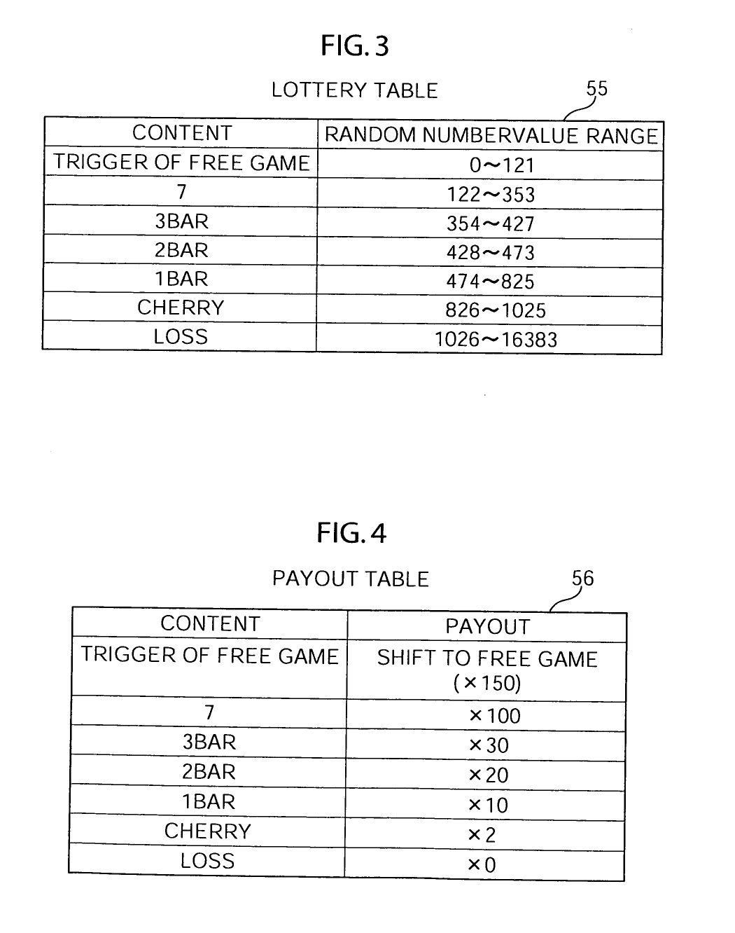

Here, when the game is played with the slot machine 1, a lottery table used when the winning combination is determined by lottery and a payout table based on the winning combination will be described based on FIG. 4. FIG. 3 is a lottery table of the winning combination in the case where the base game and the free game are played. FIG. 4 is a payout table showing the payout of the credit based on the winning combination.

As shown in tables 3 and 4, a range of random number values used in the lottery table of the winning combination are 0 to 16383, and in the case where the random number values sampled through a random number sampling circuit 119 are in the range of 0 to 121, the trigger of the free game occurs. In this case, in the variable display portion 7, the trigger symbol 51 is stop-displayed on the active payline L, and in the case of the base game, it shifts to the free game. On the other hand, in the case of the free game, a credit multiplying the number of bets betted on the active payline L by the multiplying factor (×150) is given as a payout. For example, in the case where the free game is played with a MAX (30) bet, 4500 credits are given as a payout.

Further, in the case where the random number values sampled through the random number sampling circuit 119 are in the range of 122 to 353, the winning combination of the seven (7) occurs. In this case, the seven 48 is stop-displayed on the active payline L, and the number of credits based on the number of bets and the current game rate is added as a payout. That is, in case the game is played by a value (for example, Max (30) bet) multiplying the number multiplying the number of bets by the game rate further by the payout multiplying factor (×100), 3000 credits are added as a payout.

Similarly, in the case where the sampled random number values are in the range of 354 to 427, the winning combination of the triple BARs occurs. In the case where the sampled random number values are in the range of 428 to 473, the winning combination of the double BARs occurs. In the case where the sampled random number values are in the range of 474 to 825, the winning combination of the single BARs occurs. In the case where the sampled random number values are in the range of 826 to 1025, the winning combination of the cherry occurs.

Each of the winning combination is set with the payout of multiplying factor of “×30 to ×2”, and the number of credits based on the number of bets and the current game rate is added as a payout (for example, in the case where the winning combination of cherry occurs and the game is played with 10 bets, 20 credits are added as a payout).

In the case where the sampled random number values are in the range of 1026 to 16383, a game is lost. In this case, the combination of the symbols which does not correspond to any of the winning combinations and thus become loss is stop-displayed on the active payline L, and no payout of credit is given.

While executing the free game, the number of the loss times is counted, and when the number of loss times become predetermined values, the termination conditions of the free game are changed.

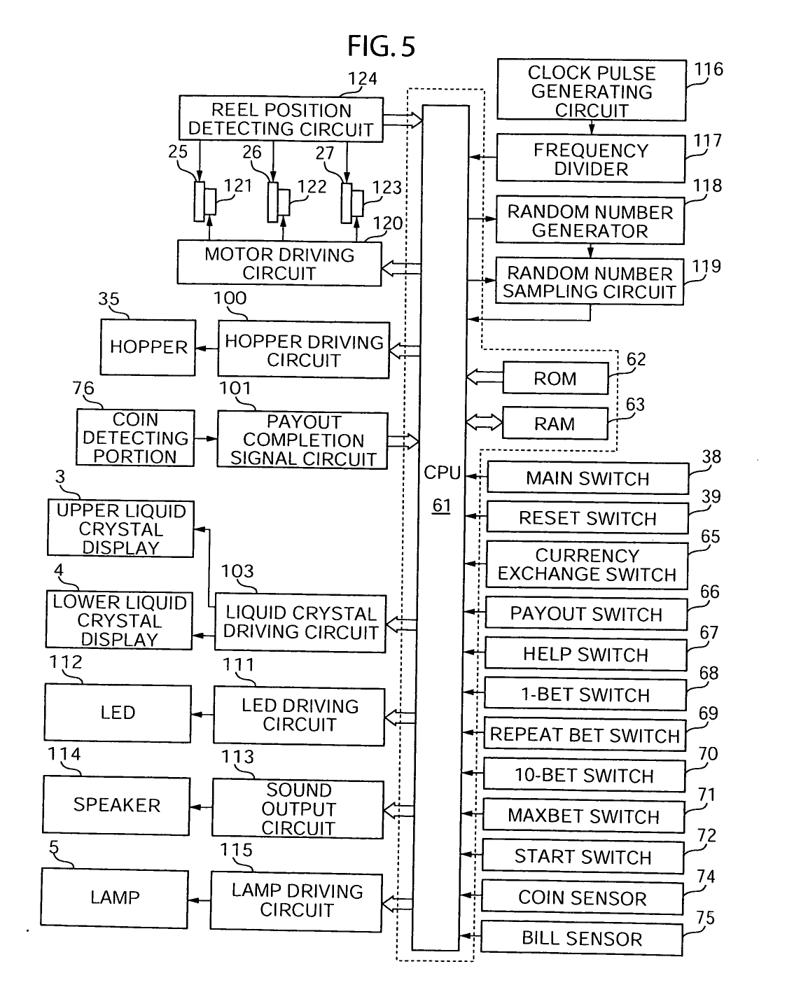

Next, the configuration according to the control system of the slot machine 1 will be described based on FIG. 5. FIG. 5 is a block diagram schematically showing a control system of the slot machine according to the present embodiment.

In FIG. 5, the control system of the slot machine 1 is basically configured by the CPU 61 as a nucleus. The CPU 61 is connected with a ROM 62 and a RAM 63. The ROM 62 is stored with a wide variety of programs, data tables, and the like necessary for controlling the slot machine 1 such as a main processing program, a base game processing program, a free game processing program, various kinds of representation programs for performing all kinds of representations for the upper liquid crystal display 3 and the lower liquid crystal display 4 accompanied with the progress of the game, a lottery table 55 (see FIG. 3) for lottery stop-display symbols for the base game and the free game, a payout table 56 based on the winning combinations (see FIG. 4) and the like to be described later. Further, the RAM 63 is a memory for temporarily storing the number of credits currently owned by the player and various data calculated by the CPU 61.

Further, the CPU 61 is connected with a clock pulse generating circuit 116 for generating a reference clock pulse and a frequency divider 117, and is also connected with a random number generator 118 for generating a random number and the random number sampling circuit 119. The random numbers sampled through the random number sampling circuit 119 are used for various types of lottery such as the winning combinations, the representations, and the like.

Further, the CPU 61 is connected with a main switch 38 for interrupting the provision of the power supply necessary to operation the slot machine 1, a reset switch 39 for initializing the status of the slot machine 1, a currency exchange switch 65 attached to the currency exchange button 11, a collect switch 66 attached to the collect button 12, a help switch 67 attached to the help button 13, a 1-BET switch 68 attached to the 1-BET button 18, a repeat BET switch 69 attached to the repeat BET button 19, a 10-BET switch 70 attached to the 10-BET switch 20, a MAXBET switch 71 attached to the MAXBET button 21, and a start switch 72 attached to the start button 17, respectively. The CPU 61, based on the switch signal outputted from each switch by the pressing of each button and the like, performs a control so as to execute corresponding various types of operations.

Then, the CPU 61 is connected with three stepping motors 121 to 123 for performing the rotation of each of the reels 25 to 27 through a motor driving circuit 120, and is connected with a reel position detecting circuit 124. When a motor driving signal is outputted from the CPU 61 to the motor driving circuit 120, each of the stepping motors 121 to 123 is rotationally driven by the motor driving circuit 120. In this manner, each of the reels 25 to 27 is rotated.

At this time, after the start of the rotation of each of the reels 25 to 27, the number of driving pulses supplied to each of the stepping motors 121 to 123 is calculated, and these calculating values are written in a predetermined area of the RAM 63. Further, a rest pulse is outputted from each of the reels 25 to 27 for each rotation, and the reset pulse is inputted to the CPU 61 through a reel position detecting circuit 124.

When the reset pulse is inputted to CPU 61 in this manner, the calculating values written in the RAM 63 are cleared to “0”, and the CPU 61 recognizes a rotational position of the symbols in each of the reels 25 to 27 based on the calculating values corresponding to the rotational position in the range of one rotation of each of the reels 25 to 27 and a symbol table correlating the rotational position of the each of the reels 25 to 27 stored in the ROM 62 and the symbols formed on the lateral surface of each of the reels 25 to 27.

Further, the CPU 61 is connected with the coin sensor 74 installed in the coin inserting slot 14 and the bill sensor 75 installed in the bill inserting slot 15, respectively. The coin sensor 74 detects the coin inserted from the coin inserting slot 14, and the CPU 61 calculates the number of coins inserted based on a coin detecting signal outputted from the coin sensor 74. Then, based on the number of coins calculated, the number of credits stored in the RAM 63 is increased.

Further, the bill sensor 75 detects the types of the bill and amount of the bill inserted from the currency inserting slot 15. The CPU 61 calculates the number of coins equivalent to the amount of the bill based on a bill detecting signal outputted from the bill sensor 75, and pays out the coins by a hopper 35.

The CPU 61 is connected with the hopper 35 through a hopper driving circuit 100. When a driving signal from the CPU 61 is outputted to the hopper driving circuit 100, the hopper 35 pays out a predetermined number of coins from the coin payout port 30.

Further, the CPU 61 is connected with a coin detecting portion 76 through a payout completion signal circuit 101. The coin detecting portion 76 is installed inside the coin payout port 30, and in the case where the payment of the predetermined number of coins from the coin payout port 30 is detected, a coin payout detecting signal is outputted from the coin detecting portion 76 to the payout completion signal circuit 101, and based on this signal, the payout completion signal circuit 101 outputs a payout completion signal to the CPU 61.

The CPU 61 is connected with the upper liquid crystal display 3 and the lower liquid crystal display 4 through a liquid crystal driving circuit 103, and the CPU 61 controls the upper liquid crystal display 3 and the lower liquid crystal display 4.

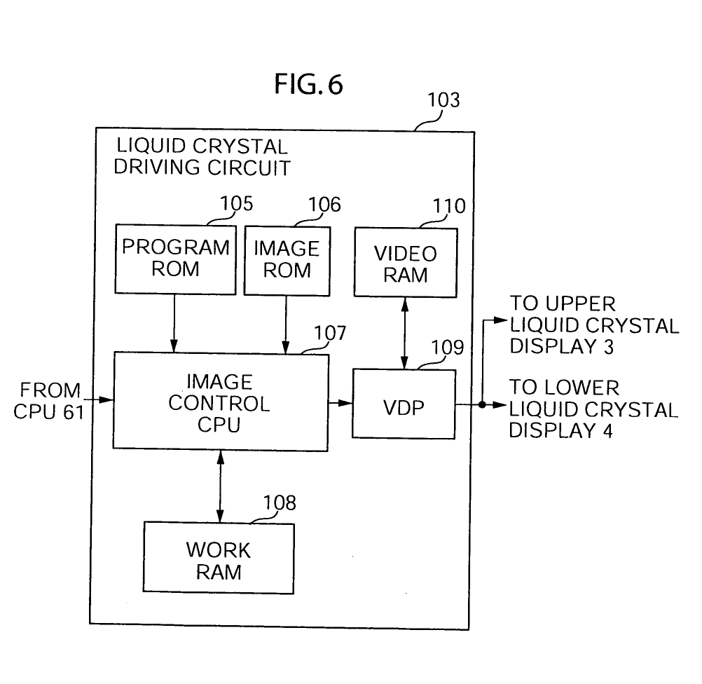

The liquid crystal driving circuit 103, as shown in FIG. 6, is configured by a program ROM 105, an image ROM 106, an image control CPU 107, a work RAM 108, a VDP (Video Display Processor) 109, a Video RAM 110, and the like.

The program ROM 105 is stored with an image control program relating to the display in the upper liquid crystal display 3 and the lower liquid crystal display 4 and various types of selection tables. The image program ROM 106 is, for example, stored with dot data for forming an image displayed in the upper liquid crystal display 3 and the lower liquid crystal display 4.

Further, an image control CPU 107, based on the parameter set in the CPU 61, and according to the image control program stored in advance inside the program ROM 105, determines the image to be displayed in the upper liquid crystal display 3 and the lower liquid crystal display 4 from among the dot data stored in advance inside the image ROM 106. The work RAM 108 is configured as temporary storage means when the image control program is executed by the image control CPU 107.

Further, the VDP 109 forms an image according to the display content determined by the image control CPU 107, and outputs it to the upper liquid crystal display 3 and the lower liquid crystal display 4.

The video RAM 110 is configured as temporary storage means when an image is formed by VDP 109.

Further, the CPU 61 is connected with an LED 112 through an LED driving circuit 111. The LED 112 is disposed in front of the slot machine 1 in large quantities, and is controlled to turn on by the LED driving circuit 111 based on a driving signal from the CPU 61 when various representations are performed.

Further, a sound output circuit 113 and a speaker 114 are connected to the CPU 61, and the speaker 114 generates effective sounds of various types when the representations of various types are performed based on the output signal from the sound output circuit 113. Moreover, a lamp driving circuit 115 and a lamp 5 are connected to the CPU 61, and the lamp 5 is turned on based on the output signal from the lamp driving circuit 115.

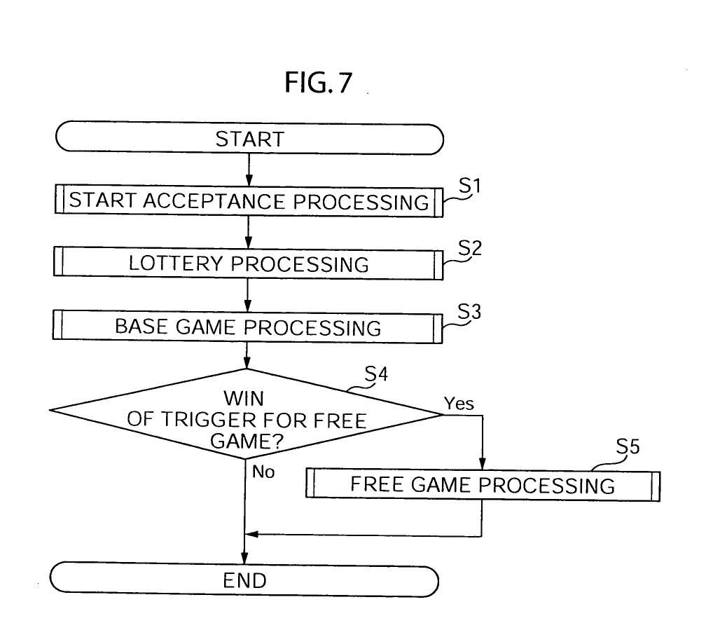

Subsequently, a main processing program executed in the slot machine 1 will be described based on FIG. 7. FIG. 7 is a flowchart of the main processing program of the slot machine 1 according to the present embodiment. Each program shown by the flowchart in FIGS. 7 to 11 is stored in the ROM 62 and RAM 63 provided for the slot machine 1, and is executed by the CPU 61.

First, the CPU 61, when starting to execute the main processing program, performs a start acceptance processing (S1). This start acceptance processing (S1) is a processing to accept the switch signals outputted from each switch based on the operation of the start button 17, the operation of the repeat BET button 19, the operation of the 1-BET button 18, the operation of the 10-BET button 20, and the operation of the MAXBET button 21.

A game is started at the point of time when the switch signals outputted from the repeat BET switch 69, the MAXBET switch 71 or the start switch 72 are accepted.

That is, in the start acceptance processing (S1), a processing is performed from the setting up of the number of bets for the active payline L up to the rotational start of each of the reels 25 to 27.

Subsequently, at S2, in the start acceptance processing (S1), the lottery processing of various types are performed based on the switch signals outputted from each switch. Specifically, the lottery of the winning combination in the base game played by using the variable display portions 6 to 8 is performed by using the random number values sampled by the random number sampling circuit 119 and the lottery table 55 (see FIG. 4), and the symbols to be stop-displayed are determined.

At S3, the base game processing is performed. In the base game processing (S3), based on the lottery result at the lottery processing (S2), processing of variable display and stop display of the symbols, payout of the credit, and the like are performed.

At S4, as a result of the lottery in the lottery process (S2), it is determined whether or not the trigger (trigger symbol 51, see FIG. 2) for the free game occurs.

In the case where the trigger for the free game does not occur (S4: NO), the main processing is terminated, and on the other hand, in the case where the trigger for the free game occurs (S4: YES), the free game processing is performed (S5). After the free game processing, the main processing is terminated.

Each processing configuring the main processing program will be described in detail later with reference to the drawings.

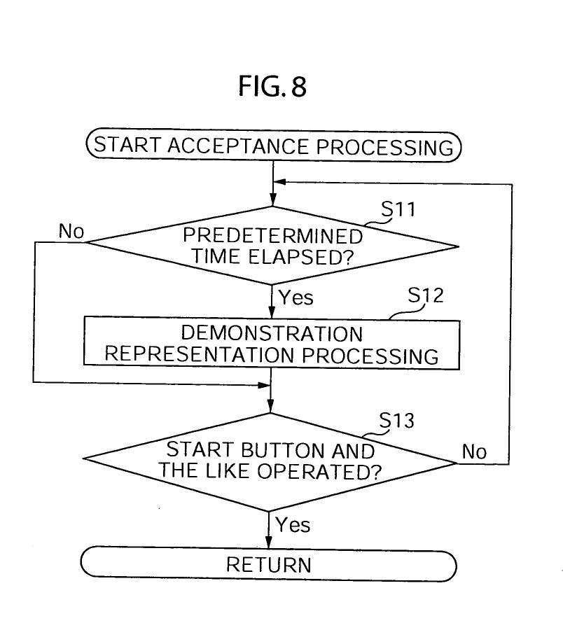

First, the start acceptance processing program executed in the start acceptance processing (S1) will be described in detail with reference to the drawing. FIG. 8 is a flowchart of the start acceptance processing program according to the present embodiment.

First, when the procedure proceeds to the start acceptance processing (S1), first, the CPU 61 determines whether or not a predetermined time (15 seconds in the present embodiment) has elapsed (S11). In the case where the predetermined time has not elapsed (S11: NO), the procedure proceeds to S13. On the other hand, in the case where it is determined that the predetermined time has elapsed (S11: YES), at S12, demonstration representations are performed in the upper liquid crystal display 3 and the lower liquid crystal display 4, and after that, the procedure proceeds to S13.

At S13, the CPU 61 determines whether or not the start button 17, the repeat BET button 19 or the MAXBET button 21 have been operated. In the case where the start button 17, the repeat BET button 19 or the MAXBET button 21 have been operated (S13: YES), the game is started with the number of bets according to the operated buttons.

That is, when the start button 17 is operated, the game is started with the number of bets set up by the 1-BET button 18 and the 10-BET button 20. When the repeat BET button 19 is operated, the game is started with the same number of bets set up the previous game. Further, when the MAXBET button 21 is operated, the game is started with the maximum number of bets (30 bets in the present embodiment) possible in one game.

On the other hand, in the case where it is determined that none of the buttons is operated (S13: NO), the procedure returns to S11 again, and repeatedly performs the above-described processing. In the case where any of the buttons is operated (S13: YES), even in the midst of the demonstration representation processing (S12), the procedure returns to the main processing program, and proceeds to S2.

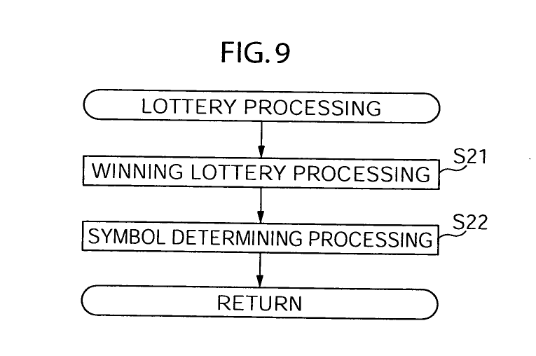

Next, a lottery processing program executed in the lottery processing (S2) of the main processing program will be described in detail with reference to the drawing. FIG. 9 is a flowchart of the lottery processing program.

When the procedure terminates the start acceptance processing (S1), and proceeds to the lottery processing (S2), first, the CPU 61 executes a winning lottery processing (S21). In the winning lottery processing (S21), the CPU 61 samples the random numbers by the random number sampling circuit 119, and based on the sampled random number values and the lottery table 55 (see FIG. 4), a winning combinations are determined. Then, the stop position of each of the reels 25 to 27 is determined so as to configure the winning combinations determined by the winning lottery processing (S21), and the symbols displayed on the active payline L are determined (S22).

After determining the symbols of each of the reels 25 to 27 stopped on the active payline L, the lottery processing (S2) is terminated, and the procedure proceeds to the base game processing (S3) of the main control program.

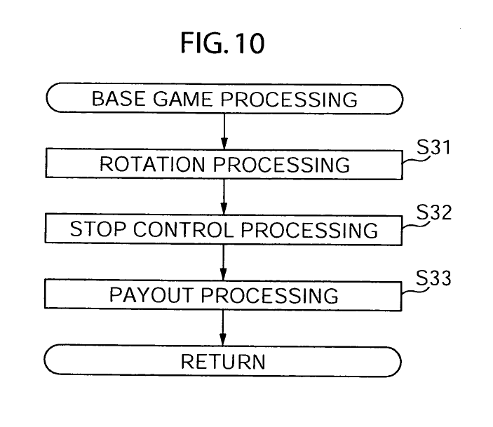

Subsequently, the base game processing program executed in the base game processing (S3) of the main processing program will be described in detail with reference to the lottery. FIG. 10 is a flowchart of the base game processing program.

When the procedure terminates the lottery processing (S2) and proceeds to the base game processing (S3), first, the CPU 61, at S31, based on the switch signal accepted at the start acceptance processing (S1), starts the rotation of each of the reels 26 to 27 (S31).

When the rotational driving of each of the reels 25 to 27 is started (S31) and scrolling of each symbol is performed at the variable display portions 6 to 8, at S32, the stop control processing is performed.

In the stop control processing (S32), the rotation of each of the reels 25 to 27 is stopped so that a symbol determined by the winning lottery processing (S21) and a symbol deciding processing (S22) is stop-displayed on the active payline L.

At S33, according to a combination of symbols stop-displayed on the active payline L in each of the variable display portions 6 to 8 at S32, that is, the winning combinations determined by the winning lottery processing (21), the payout for the game this time is calculated based on the number of bets for the active payline L and the payout table (see FIG. 4). Then, the credit equivalent to the calculated payout is paid out, and after that, the procedure returns to the main processing program, and proceeds to S4.

In the lottery processing (S2), until wining the winning combination of the trigger symbol 51 (S4: YES), the above-described start acceptance processing (S1), the lottery processing (S2), and base game processing (S3) are repeated.

On the other hand, as described above, in the case of occurring the winning of the trigger symbol 51 (S4: YES), after the termination of the base game processing (S3), the procedure shifts to the free game processing (S5), and the free game is executed.

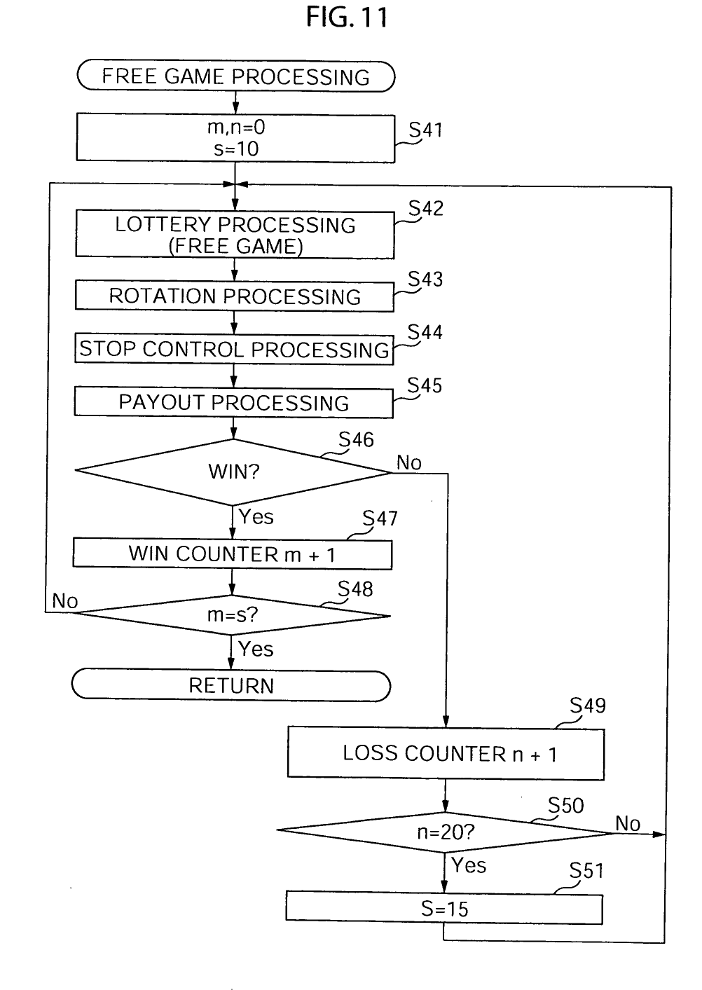

Here, the free game processing (S5) will be described in detail with reference to the lottery. FIG. 11 is a flowchart of the free game processing program.

When the procedure proceeds to the free game processing (S5), the CPU 61, first, sets the win counter m, the loss counter n, and the free game termination condition values s stored in the RAM 63 to an initial value (S41).

Here, the free game in the slot machine 1 according to the present embodiment is terminated at a point of time when the same number of winning as the numerical values shown by the free game termination condition values s is available. The free game termination condition values s are set to “s=10” at S41, and hence, as long as a specific condition to be described later is not satisfied, the free game is terminated at a point of time when ten winnings are available during the free game.

The win counter m is a counter for counting the number of winning times for the winning combination during the free game this time. Consequently, at a point of time when the values of this win counter m become identical with the above-described free game termination condition values s, the free game is terminated.

The free game in the present embodiment, as described above, is terminated, in principle, at a point of time when the number of winning times during the free game reaches ten, but if certain specific conditions are satisfied, the free game is continued until further five winnings. That is, when certain specific conditions are satisfied, the free game can be executed until 15 winnings are obtained during the free game.

Here, in the present embodiment, the specific conditions are to lose 20 times in the lottery before the number of winning times during the free game becomes 10.

Consequently, at S41, the values of the win counter m and the loss counter n are set to “m=0” and “n=0” which are the initial values, and the free game termination condition values s are set to “s=10” which is the initial value. After having set the win counter m, the loss counter n, and the free game termination condition values s to the initial values (S41), the procedure proceeds to S42.

At S42, the CPU 61 performs the lottery process during the free game. This lottery processing performed during the free game is the same processing as the lottery process (S2) in the above-described base game.

That is, in timing with proceeding to S42, the random number values are sampled by the random number sampling circuit 119, and by using the random number values and the lottery table 55 (see FIG. 4), the winning combination is determined. Then, the stopping status of each of the reels 25 to 27 is determined so that the symbol configuring the determined winning combination stops on the active payline L.

At S43, in timing with proceeding to S42, the rotation of each of the reels 25 to 27 is started. When the rotational driving of each of the reels 25 to 27 is started (S43) and the scrolling of each symbol is performed in the variable display portions 6 to 8, at S44, the stop control processing is performed.

In the stop control processing (S44), the rotation of each of the reels 25 to 27 is stopped so that the symbol determined in the lottery process (S42) is stopped and displayed on the active payline L.

At S45, according to a combination of symbols stopped and displayed on the active payline L in each of the variable display portions 6 to 8 at S44, that is, the winning combination determined in the lottery processing (S42), the payout for the game played this time is calculated based on the number of bets for the active payline L and the payout table (see FIG. 4). Then, the credit equivalent to the calculated payout is paid out, and the procedure proceeds to S46.

Here, during the free game, in case the winning of the trigger symbol 51 occurs, different from the executing time of the base game, the credit multiplying the payout multiplying factor (x 150) corresponding to the winning of the trigger symbol 51 for the number of bets for the active payline L is given as a payout. For other winning combinations, the credit multiplying the payout multiplying factor (see FIG. 4) of the winning combinations for the number of bets is given similarly to the base game.

At S46, in the immediately preceding lottery processing (S42), it is determined whether or not any of the winning combinations occur. Here, as a result of the lottery processing (S42), in case the winning combination occurs (S46: YES), the procedure proceeds to S47. On the other hand, in case the result of the lottery processing (S42) is “loss” (S46: NO), the procedure proceeds to S49.

As a result of the lottery processing (S42), at S47 to which the procedure proceeds in case the winning combination occurs (S46: YES), the CPU 61 adds 1 to the values of the above-described win counter m.

At S48, it is determined whether or not the numerical values of the win counter m and the values of the free game termination condition values s are identical. In case the numerical values of the win counter m and the numerical values of the free game termination condition values s are identical (S48: YES), it satisfies the termination conditions of the free game, and hence, the free game processing (S5) is terminated, and the procedure returns to the main processing program.

On the other hand, in case the numerical values of the win counter m and the numerical values of the free game termination condition values s are not identical (S48: NO), the procedure returns to S42 again, and performs a processing to execute one game of the free game.

On the other hand, as a result of the lottery processing, at S49 to which the procedure proceeds in case the winning combination does not occur, but the result corresponds to the “loss” (S46: NO), the CPU 61 adds 1 to the values of the loss counter n.

At S50, the CPU 61 determines whether or not the numerical values of the loss counter n are “20”. That is, it is determined whether or not the game where the winning combination does not occur is played 20 times during the free game, and at a point of time when the game where the winning combination does not occur is played 20 times (S50: YES), the procedure proceeds to S51. On the other hand, the number of time of the games where no winning combinations occur is not 20 (S50: NO), the procedure returns to S42 again, and performs a processing to execute one game of the free game.

At S51, since the specific condition that “the number of game play times where the winning combination does not occur during the free game is 20” is satisfied (S50: YES), the numerical values of the free game termination condition values s are changed from “10” to “15”. After changing the numerical values of the free game termination condition values s to “15” (S51), similarly, the procedure returns to S42 again, and performs a processing to execute one game of the free game.

In this manner, in the free game of the slot machine 1 according to the present embodiment, until the values of the win counter m become at least 10, that is, until the occurrence of winning combinations in the free game is 10 times, the free game is continuously played. In this manner, by obtaining the winning of the trigger symbol 51, many credits can be acquired, so that the degree of excitement involved in the winning in the free game of the slot machine 1 is increased, and this results in providing fresh interest in the slot machine 1 of the player.

When the numerical values of the loss counter n reach 20 (S50: YES) before the numerical values of the win counter m become 10 (S48: YES), this satisfies the specific conditions, and the numerical values of the free game termination condition values s are changed from “10” which are the initial setting values to “15”.

The numerical values of the free game termination condition values s are changed to “15”, so that the termination conditions of the free game this time, that is, “the winning combination in the free game occurs 10 times” is changed to “the winning combination in the free game occurs 15 times”.

Consequently, by satisfying the above-described specific conditions, the occurrence of the winning combination further five times is secured, and hence, the player can acquire many credits by satisfying the specific conditions. In the conventional free game, the player, who cannot help but be simply chagrined at the winning combination not occurring, is encouraged to expect the establishment of the specific conditions to be satisfied by the loss as a result of the lottery.

As a result, the player can enjoy one game obtaining winning combinations in the free game as before, and moreover, even in case the winning combination does not occur, the player can enjoy expectation of the establishment of the specific conditions.

In this manner, in the slot machine 1 according to the present embodiment, since the player can sufficiently enjoy the free game regardless of whatever lottery result is brought about by one game of the free game, it is possible to provide fresh excitement for the player who plays the slot machine 1.

As described above in detail, the slot machine 1 according to the present invention, when the winning of the trigger symbol 51 occurs (S4: YES), proceeds to the free game processing (S5). In the free game processing (S5), the numerical values of the win counter m are added with 1 (S47) every time the winning combination occurs, and only when the numerical values of the win counter m become the same as the free game termination condition values s, the processing is terminated (S48: YES).

Consequently, when the player proceeds to the free game processing (S5), the winning up to the number of times defined by the free game termination condition values s is at least confirmed, and the payout based on that winning can be acquired. This will not betray the expectation of the player for the free game, but will sufficiently demonstrate the effect as the feature game.

Moreover, in the slot machine 1 according to the present embodiment, in case the winning combination does not occur during the free game processing (S5), that is, in case the lottery result corresponds to the “loss” (S46: NO), the numerical values of the loss counter n are added with 1 every time (S49). In case the numerical values of the loss counter n reach 20 (S50: YES), the numerical values of the free game termination condition values s which are the termination conditions of the free game are changed from “10” to “15”.

That is, the number of loss times reaches 20 before the number of winning times reaches 10 since starting the free game, so that the free game can be played until the number of winning times in the free game reaches 15. In this manner, the player is allowed to execute the free games five times more than playing the base free game and can acquire the payout according to the winning combinations relating to the lottery increased to five times.

Consequently, the player, even when no winning combinations occur during the free game, can enjoy the free game, so that the degree of disappointment of the player regarding no occurrence of winning combinations can be reduced.

The gaming machine according to the first embodiment of the present invention proceeds from the first game (base game), and in case the gaming machine executes the second game (free game) providing the payout according to each of the winning combinations in case the symbol combination determined by the lottery unit corresponds to the winning combinations without using the gamely medium, the gaming machine counts the number of winning time during the second game by the number of winning time, and terminates the second game by satisfying the second game termination conditions based on the number of winning time during the second game.

As a result, in the second game, the player can at least acquire the payout based on the number of the winning time which is defined by the second game termination conditions. Consequently, this gaming machine does not betray expectation of the player for the second game, and the player can sufficiently enjoy the second game.

A gaming machine according to a second embodiment of the present invention counts the number of loss times during the second game by the number of loss counter, and changes the termination conditions of the second game by satisfying the termination condition changing conditions by the number of loss times.

As a result, even in case the winning combination does not occur during the second game, the termination conditions of the second game can be expected to be relaxed, so that the degree of disappointment of the player regarding no occurrence of any winning combinations can be reduced.

Further, in this gaming machine, the second game is continued till the second game termination conditions are satisfied based on the number of winning times, and hence, the relaxation of the second game termination conditions leads to the increase of the payout acquirable, and thus, even if no winning combinations occur, the second game can be enjoyed.

### MODIFIED EXAMPLE

The present invention is not limited to the above-described embodiments, and can be variously modified without departing from the scope of the invention.

For example, in the slot machine 1 according to the present embodiment, as a condition for shifting to the free game, though the winning of the trigger symbol 51 has been taken as the condition, it is not limited thereto, but there exist various types of conditions as the condition for shifting to the free mage.

For example, the shift to the free game may be made by obtaining another winning combination (for example, the winning combination of the seven 48) in the present embodiment or the shift to the free game may be made by being stopped in the mode where the occurrence of the winning combinations is not recognizable from the symbols stopped on the active payline L in the variable display portions 6 to 8, though the winning combination for shifting to the free game occurs (so-called mystery bonus).

Further, in the present embodiment, in case the termination conditions of the free game are satisfied, the payout alone in that game is paid out as a credit. As a modification of this embodiment, if this termination conditions are satisfied (that is, at the 10th or 15th time in the number of winning times during the free game in the present embodiment), an additional payout may be paid out for the credit in addition to the payout obtained during the free games. Further, as a condition for paying the additional payout at such free game terminating time, it may be stipulated that the numerical values of the loss counter n become 20, and the termination conditions are changed. That is, in this case, the additional payout is paid in the winning of the 15th time in the free game.

In the slot machine 1 according to the present embodiment, with respect to the lottery table used for the lottery of winning combinations during the free game, though the same lottery table as one before the change of termination condition is used even in case the number of winning times is changed from 10 to 15, this table may be changed.

For example, if the lottery table used after the change of termination conditions is configured to be modified to the table where a winning ratio is higher than the previous lottery table, the number of loss times 20 can be reached much earlier, and the free game can be played much more by the lottery table having a high winning ratio.

In this manner, the player can enjoy even in case the lottery result is loss in one game of the free game, thereby providing a fresh interest in the slot machine 1.

Moreover, during the free game executing time, the numerical values of the win counter m and the loss counter n may be displayed in the lower liquid crystal display 4 so as to notify the values to the player. In this manner, the player can grasp the number of winning times and the number of loss times in the free game, so that he or she can savor nervousness involved in the termination of the free game or upliftment based on extension of the game period of the free game.

In the present embodiment, while both of the base game and the free game have been explained in the mode of using the reels 25 to 27, either one of the games may be played by the display of the lower liquid crystal display 4, that is, by so-called video reel or it is also possible to execute both of the base game and the free game by the video reel.

Further, while the slot machine 1 according to the present embodiment is a slot game using three reels 25 to 27, the number of reels is not limited to thereto, and the number of the active payline L on which the player bets the credit is not limited to one line only. That is, if it is a slot machine capable of executing the free game, the present invention can be applied to that slot machine.

Additional advantages and modifications will readily occur to those skilled in the art. Therefore, the invention in its broader aspects is not limited to the specific details or representative embodiments shown and described herein. Accordingly, various modification may be made without departing from the spirit or scope of the general inventive concept as defined by the appended claims and their equivalents.

What is claimed is:

1. A gaming machine comprising:
a display for variably displaying a plurality of symbols, and displaying a combination of symbols by stopping to variably displaying the symbols;
a lottery unit for determining a combination of symbols displayed in the display;
a first game control unit for executing a first game for providing a payout according to each winning combination in case the combination of symbols determined by the lottery unit corresponds to winning combinations;
a second game control unit for shifting from the first game to a second game based on a predetermined condition and executing the second game for providing a payout according to each winning combination in the case that the combination of symbols determined by the lottery unit corresponds to winning combinations; and
a win counter for counting the number of winning times during the second game,
wherein:
the second game is terminated when the counting result of the win counter satisfies a second game termination condition based on the number of winning times during the second game.

2. The gaming machine according to claim 1, wherein the gaming machine provides an additional payout when the counting result of the win counter satisfies the second game termination condition based on the number of winning time during the second game.

3. The gaming machine according to claim 1, wherein the gaming machine further comprises an indicator for indicating the counting result of the win counter.

4. The gaming machine according to claim 1, wherein the gaming machine further comprises:
a loss counter for counting the number of loss times during the second game; and
a termination condition changing unit for changing the termination condition of the second game whereby the counting result of the loss counter satisfies the termination condition changing condition based on the number of loss times during the second game.

5. The gaming machine according to claim 4, wherein the gaming machine provides an additional payout when the counting result of the win counter satisfies the second game termination condition based on the number of winning time during the second game.

6. The gaming machine according to claim 4, wherein the gaming machine provides an additional payout when the termination condition changing unit changes the termination condition of the second game.

7. The gaming machine according to claim 4, wherein the gaming machine further comprises an indicator for indicating at least one of the counting result of the win counter and the counting result of the loss counter.
